(19) United States
(12) Patent Application Publication
(10) Pub. No.: US 2012/0248756 A1
(43) Pub. Date: Oct. 4, 2012

(54) Gripping and Identification Tab

(76) Inventor: Payette S. Still, Graham, WA (US)

(21) Appl. No.: 13/079,385

(22) Filed: Apr. 4, 2011

(51) Int. Cl. B42D 15/00

(52) U.S. Cl. 283/81

(57) ABSTRACT

The present invention in several embodiments is a device for identifying and providing a gripping means for cards or the like. In a preferred embodiment the invention is a self adhesive plastic tab that adheres to at least two sides of a card at an edge of said card. The plastic tab is bifurcated with adhesive between the bifurcation to allow for adhesion to at least two sides of a card. The plastic tab could be produced through an extrusion process, injection molding or by affixing two sheets of plastic film together. The adhesive could be any suitable adhesive known in the art, but preferred embodiments of the invention use pressure sensitive adhesives, removable adhesives, contact adhesives and one-part adhesives. Most preferably the adhesive used is a pressure sensitive adhesive.

### FIELD OF THE INVENTION

The present invention relates, in general, to card management devices and methods and, more particularly, this invention relates to a plastic tab for identifying and removing cards from a wallet.

### BACKGROUND OF THE INVENTION

Prior to the conception and development of the present invention, tabbing devices, as are generally well known in the prior art, have been used for the identification of files on a filing cabinet. However, no tabbing devices have been developed for use as an identifying means and as a means for easy removal from a pocket of a wallet or the like. The prior art has used tabs primarily for identifying files or other articles within a larger set of files or other articles. However none of the prior art has disclosed or suggested a need for tabs to aid in the removal of cards from a tightly packed wallet or the like.

### SUMMARY OF THE INVENTION

The present invention in several embodiments is a device for identifying and providing a gripping means for cards or the like. In a preferred embodiment the invention is a self adhesive plastic tab that adheres to at least two sides of a card at an edge of said card. The plastic tab is bifurcated with adhesive between the bifurcation to allow for adhesion to at least two sides of a card. The plastic tab could be produced through an extrusion process, injection molding, by affixing two sheets of plastic film together or by splitting a plastic sheet to produce a suitable bifurcation. The adhesive could be any suitable adhesive known in the art, but preferred embodiments of the invention use pressure sensitive adhesives, removable adhesives, contact adhesives and one-part adhesives. Most preferably the adhesive used is a pressure sensitive adhesive.

The bifurcated structure of the tab in combination with the adhesive in the bifurcation benefits the holding strength and durability of the present invention. By adhering to opposite sides of a card the tab becomes difficult to remove from the card, this is in part because of the increased surface area for bonding and because when the tab is bent the adhesive on a first side is in tensile stress while a second side is in compression. Substantial tensile stress can break an adhesive bond while compression strengthens the adhesive bond, particularly for pressure sensitive adhesives.

In several preferred embodiments the tab comprises identification means which could comprise Braille, ornamentation, symbols, color codes, jewelry or any suitable visual or tactile identification means.

In several embodiments of the present invention the identification means is Braille, raised stones, affixed gems, or another tactile identification means. These tactile identification means can also aid in the gripping of the tabs by providing a course surface for a user to grip.

In several embodiments of the present invention the identification means could be attached to the tab by any suitable attachment means, including adhesives, chain links, chains, cords, straps, fasteners, or hinges. Several of the preferred embodiments use flexible attachment means such as chain links, chains, cords, straps, and hinges. These flexible attachment means can further aid in the gripping of a tab and the associated card by allowing a user more area to grasp, a wider range of motion for grasping and additional advantages that should become apparent to one skilled in the art.

### OBJECTS OF THE INVENTION

It is, therefore, one of the primary objects of the present invention is to provide a self adhesive tab that can be applied to the edge of a credit card or similar card.

Another object of the present invention is to provide a self adhesive tab that can be strongly secured to the edge of a credit card or similar card to allow a user to pull the tab even when the card is tightly held by the pocket of a wallet.

Still another object of the present invention is to provide a self adhesive tab that can be strongly secured to the edge of a credit card or similar card to allow a user to quickly identify the card without the need for visual inspection of the card.

In another embodiment the invention is a self adhesive tab that can be strongly secured to the edge of a credit card or similar card to allow a user to quickly identify the card without the need for visual inspection of the card or the tab.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 shows a schematic side view of a preferred embodiment of the present invention about to be attached to a card.

FIG. 2 shows a schematic side view of a preferred embodiment of the present invention attached to a card.

FIG. 3 is a frontal view of the present invention attached to a card.

FIG. 4 is a frontal view of the present invention attached to a card.

FIG. 5 shows a general frontal view of the present invention 10 installed on a plurality of cards 18 in a wallet 24.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

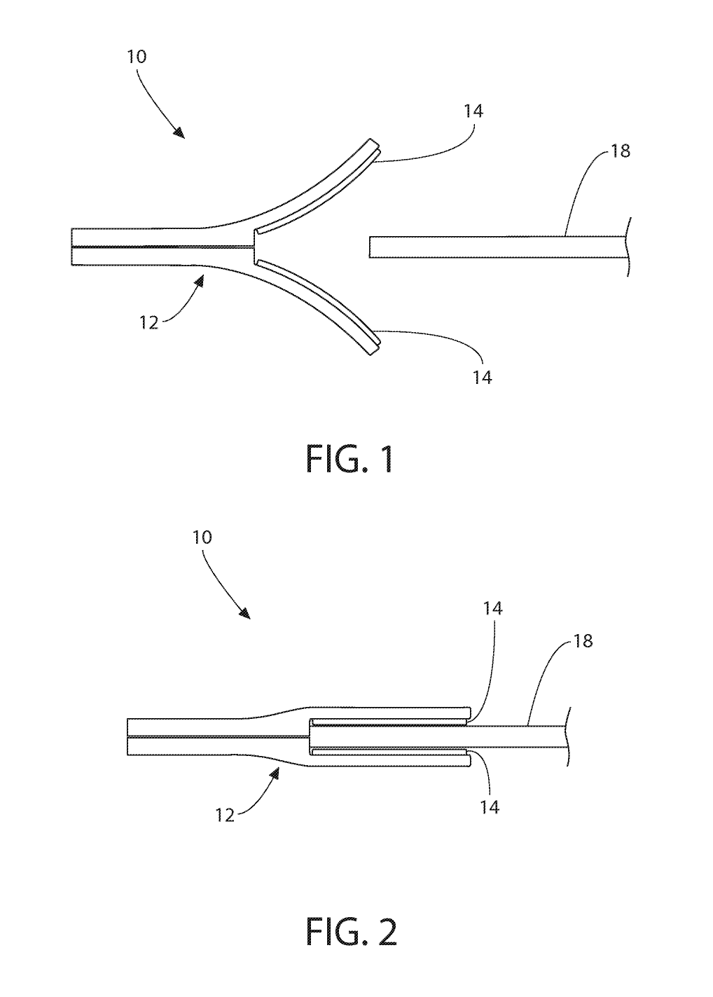

Reference is now made, more particularly, to FIGS. 1-4.

FIG. 1 shows a schematic side view of a preferred embodiment of the present invention 10 about to be attached to a card 18. The present invention 10 preferably comprises a bifurcated tab element 12, adhesive elements 14 and an identifying element 16 (not shown). Adhesive elements 14 are intended to be adhered to a card 16, thus securely affixing bifurcated tab element 12 to card 16. Bifurcated tab element 12 could be constructed of any suitable material known in the art, but preferably bifurcated tab element 12 is constructed from a plastic or the like. Adhesive elements 14 could be constructed from any suitable adhesive, epoxy, resin, or the like.

FIG. 2 shows a schematic side view of a preferred embodiment of the present invention attached to a card 18. The present invention 10 preferably comprises a bifurcated tab element 12, adhesive elements 14 and an identifying element 16 (not shown).

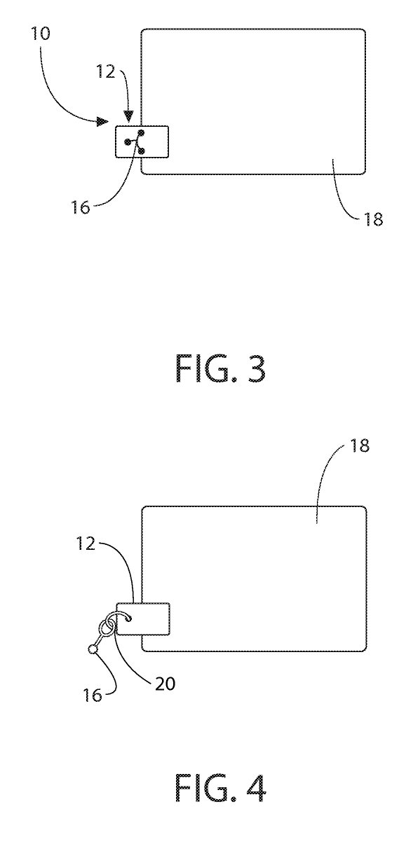

FIG. 3 gives a frontal view of the present invention 10 attached to a card 18. The present invention 10 preferably comprises a bifurcated tab element 12, adhesive elements 14 (not shown) and an identifying element 16. The identifying element 16 shown in FIG. 3 could be any indicia, Braille, ornamentation, symbol, color code, jewelry or any suitable visual or tactile identification means. The purpose of identifying element 16 is to aid in quick identification a card 18. Tactile means such as Braille, jewelry, texturing or other means know in the art allow for the identification of a card without the need to visually examine a particular card.

FIG. 4 gives a frontal view of the present invention 10 attached to a card 18. The present invention 10 preferably comprises a bifurcated tab element 12, adhesive elements 14 (not shown), identifying element attachment means 20 and an identifying element 16. Identifying element attachment means 20 in one embodiment comprises at least aperture through said bifurcated tab element 12. The identifying element 16 shown in FIG. 4 could be any indicia, Braille, ornamentation, symbol, color code, jewelry or any suitable visual or tactile identification means.

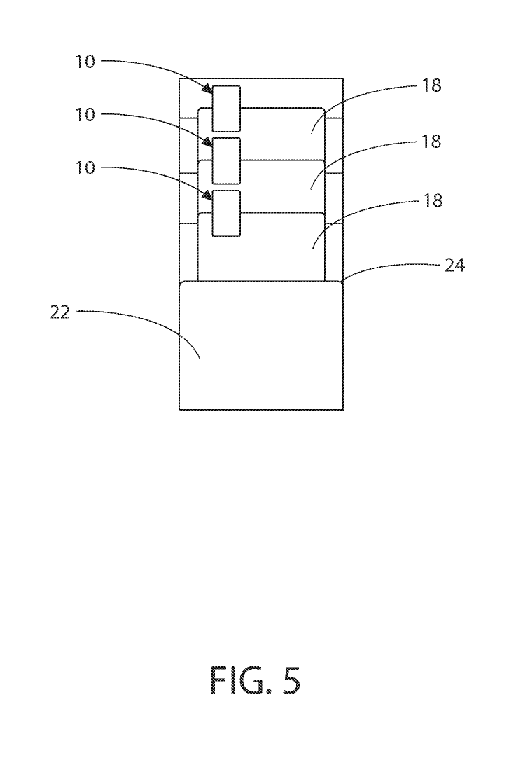

FIG. 5 provides a general frontal view of the present invention 10 installed on a plurality of cards 18 in the pockets 24 of a wallet 22.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A tab comprising;
a. a bifurcated tab element; and
b. at least one adhesive element disposed between a bifurcation of said bifurcated tab element.

2. A tab according to claim 1, wherein said bifurcated tab element further comprises an identification means.

3. A tab according to claim 1, wherein said bifurcated tab element further comprises a tactile identification means.

4. A tab according to claim 1, wherein said bifurcated tab element further comprises a visual identification means.

5. A tab according to claim 1, wherein said bifurcated tab element further comprises an identification means, and
a means for flexibly attaching said identification means to said bifurcated tab element.

6. A tab according to claim 1, wherein said bifurcated tab element further comprises an identification means, and
at least one chain link for flexibly attaching said identification means to said bifurcated tab element.

7. A tab according to claim 1, wherein said at least one adhesive element comprise a pressure sensitive adhesive.

8. A tab comprising;
a. a bifurcated tab element; and
b. at least two adhesive elements disposed between a bifurcation of said bifurcated tab element.

9. A tab according to claim 8, wherein said bifurcated tab element further comprises an identification means.

10. A tab according to claim 8, wherein said bifurcated tab element further comprises a tactile identification means.

11. A tab according to claim 8, wherein said bifurcated tab element further comprises a visual identification means.

12. A tab according to claim 8, wherein said bifurcated tab element further comprises an identification means, and
a means for flexibly attaching said identification means to said bifurcated tab element.

13. A tab according to claim 8, wherein said bifurcated tab element further comprises an identification means, and
at least one chain link for flexibly attaching said identification means to said bifurcated tab element.

14. A tab according to claim 8, wherein said at least two adhesive elements comprise a pressure sensitive adhesive.

15. A tab comprising;
a. a plastic film bifurcated tab element;
b. at least two adhesive elements disposed between a bifurcation of said bifurcated tab element; and
c. an identification means.

16. A tab according to claim 15, wherein said identification means comprises a tactile identification means.

17. A tab according to claim 15, wherein said identification means comprises a visual identification means.

18. A tab according to claim 15, wherein said bifurcated tab element further comprises a means for flexibly attaching said identification means to said bifurcated tab element.

19. A tab according to claim 15, wherein said bifurcated tab element further comprises at least one chain link for flexibly attaching said identification means to said bifurcated tab element.

20. A tab according to claim 15, wherein said at least two adhesive elements comprise a pressure sensitive adhesive.
